(19) United States
(12) Patent Application Publication
(10) Pub. No.: US 2020/0073922 A1
(43) Pub. Date: Mar. 5, 2020

(54) SYSTEM AND METHOD FOR VOCABULARY ALIGNMENT

(71) Applicant: Daniel L. Coffing, Fairfax, VA (US)

(72) Inventor: Daniel L. Coffing, Fairfax, VA (US)

(21) Appl. No.: 16/559,519

(22) Filed: Sep. 3, 2019

Related U.S. Application Data
(60) Provisional application No. 62/726,116, filed on Aug. 31, 2018.

(51) Int. Cl. G06F 17/24; G06F 17/27

(52) U.S. Cl. CPC G06F 17/24; G06F 17/2705; G06F 17/2775

(57) ABSTRACT

Aspects of the present disclosure involve systems and methods for aligning terminology used in dialogue between participants. In particular, where participants use terms and/or phrases in distinct manners, systems and methods discussed in this disclosure may identify said mismatched terms and/or phrases and provided aligned outputs in the form of replacement terms and phrases and/or an explanation of the identified mismatch. For example, homographs or terms with distinct meanings across disciplines can confuse dialogue and cause participants to “talk past each other” and the like. In some examples, term or phrase meanings may vary based on respective participant usage histories. While the disclosure depicts alignment of homographs, it is understood that this is for the sake of clarity only and that the methods and systems herein disclosed can also be used to align or identify misaligned terms on bases of degree, moral and/or social connotations, emotional impact, etc.

### CROSS-REFERENCE TO RELATED APPLICATIONS

The present patent applications claims the priority benefit of U.S. provisional patent application 62/726,116 filed Aug. 31, 2018, the disclosure of which is incorporated by reference herein.

### BACKGROUND OF THE INVENTION

### 1. Field of Technology

The present invention relates to aligning disparate vocabularies. In particular, the present invention relates to identifying misaligned vocabularies used in a dialogue and generating alternative word and phrase choices to realign dialogue.

### 2. Description of the Related Art

Different domains use shared terms in different ways. Even within a single domain, a term may have multiple meanings based on who is using it, when that person is using it, and how that person is using it. In discussions and other dialogue it is often common for participants to use the same term in misaligned or even inconsistent ways. In many cases, misaligned vocabulary usage can be the root of disagreement. It is often the case that participants are not even aware of inconsistent or unaligned term usage and so the disagreement and/or misunderstanding continues unrectified.

It is with these observations in mind, among others, that aspects of the present disclosure were concerned and developed.

### SUMMARY OF THE CLAIMED INVENTION

Aspects of the present disclosure involve systems and methods for aligning terminology used in dialogue between participants. In particular, where participants use terms and/or phrases in distinct manners, systems and methods discussed in this disclosure may identify said mismatched terms and/or phrases and provided aligned outputs in the form of replacement terms and phrases and/or an explanation of the identified mismatch. For example, homographs or terms with distinct meanings across disciplines can confuse dialogue and cause participants to “talk past each other” and the like. In some examples, term or phrase meanings may vary based on respective participant usage histories. While the disclosure depicts alignment of homographs, it is understood that this is for the sake of clarity only and that the methods and systems herein disclosed can also be used to align or identify misaligned terms on bases of degree, moral and/or social connotations, emotional impact, etc.

However, dialogue between participants, such as in the case of an argument, can be parsed to identify misaligned vocabulary. The misaligned vocabulary can be neutralized and replacement terms or phrases can be recommended based on participant usage within the dialogue and also historical usage in order to align the dialogue. In some examples, the neutralized terms can be provided to participants, alone or with replacement terms, to further highlight or emphasize explicitly concept definitions and so provide participants with an understanding to avoid future confusion.

Further, other information, such as social network data (e.g., social graphs, political affiliations, group participation, etc.), can be used to more accurately determine vocabulary usage and/or intent in a dialogue, as well as realign said vocabulary so that all participants are discussing the same ideas and concepts.

### BRIEF DESCRIPTION OF THE DRAWINGS

FIG. 1 is an example operating environment in which methods and systems of the present disclosure may be implemented, in accordance with various embodiments of the subject technology;

FIG. 2A is a block diagram of a system for aligning terminology in a dialogue, in accordance with various embodiments of the subject technology;

FIG. 2B illustrates an example vocabulary alignment visualization;

FIG. 3 is a flowchart of a method for aligning terminology in a dialogue, in accordance with various embodiments of the subject technology; and

FIG. 4 is a system diagram of an example computing system that may implement various systems and methods discussed herein, in accordance with various embodiments of the subject technology.

### DETAILED DESCRIPTION

Aspects of the present disclosure involve systems and methods for aligning terminology used in dialogue between participants. In particular, where participants use terms and/or phrases in distinct manners, systems and methods discussed in this disclosure may identify said mismatched terms and/or phrases and provided aligned outputs in the form of replacement terms and phrases and/or an explanation of the identified mismatch. For example, homographs or terms with distinct meanings across disciplines can confuse dialogue and cause participants to “talk past each other” and the like. In some examples, term or phrase meanings may vary based on respective participant usage histories. While the disclosure depicts alignment of homographs, it is understood that this is for the sake of clarity only and that the methods and systems herein disclosed can also be used to align or identify misaligned terms on bases of degree, moral and/or social connotations, emotional impact, etc.

However, dialogue between participants, such as in the case of an argument, can be parsed to identify misaligned vocabulary. The misaligned vocabulary can be neutralized and replacement terms or phrases can be recommended based on participant usage within the dialogue and also historical usage in order to align the dialogue. In some examples, the neutralized terms can be provided to participants, alone or with replacement terms, to further highlight or emphasize explicitly concept definitions and so provide participants with an understanding to avoid future confusion.

Further, other information, such as social network data (e.g., social graphs, political affiliations, group participation, etc.), can be used to more accurately determine vocabulary usage and/or intent in a dialogue, as well as realign said vocabulary so that all participants are discussing the same ideas and concepts.

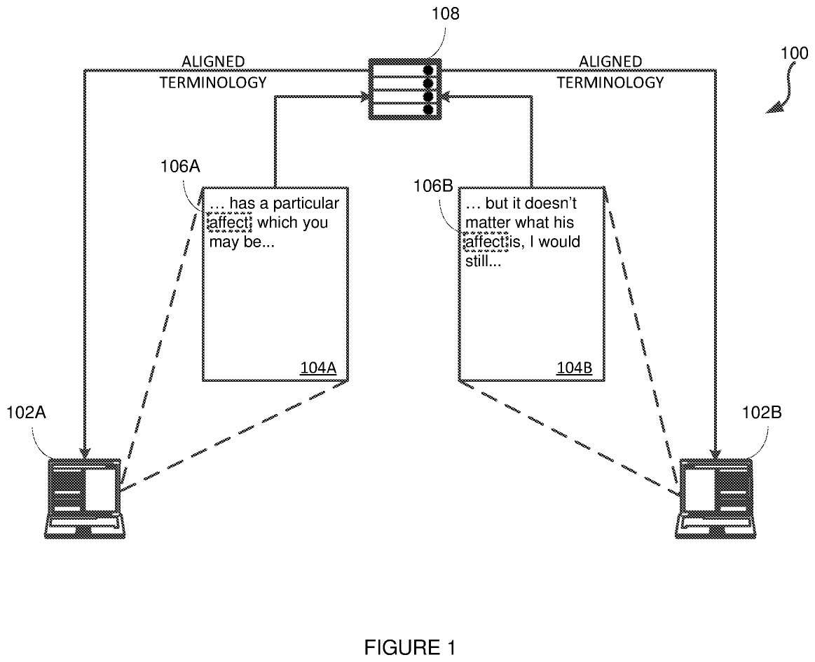

FIG. 1 depicts an operating environment 100 for aligning vocabulary. Here, users engage in dialogue over, for example, a forum thread or the like via computers 102A-B. While FIG. 1 depicts a text based dialogue, it will be understood that any dialogue can be processed to identify misaligned vocabulary such as, for example, spoken dialogue, correspondence (e.g., email, mail, etc.), and the like.

A message (e.g., forum post or response, personal message, etc.) 104A is processed by the system. In some examples, message may be automatically scanned and processed as part of an automated service via, widget, API integration, and the like. In some examples, users may manually submit dialogue having vocabulary which they wish to align. Nevertheless, a message 104B is submitted by computer 102B in response.

As can be seen, message 104A and message 104B use the word “affect” differently. In particular, message 104A refers to an “affect” in the context of an emotional state or reaction, whereas message 104B uses “affect” to refer to an impact or causal relationship to something. A server 108 receives messages 104A-B and identifies the misaligned vocabulary, indicated here as 106A-B (e.g., usage of “affect”). In some examples, server 108 may also host a forum for messages 104A-B and include vocabulary alignment processes in the form of plugins, API integrations, widgets, and other integrations as will be apparent to a person having ordinary skill in the art.

Server 108 then processes the identified misaligned vocabulary 104A-B and generates aligned formations for providing aligned terminology back to respective computers 102A-B. The aligned terminology can be in the form of a transformed and corrected statement, an explanation of the identified misalignment, or some mix of the two.

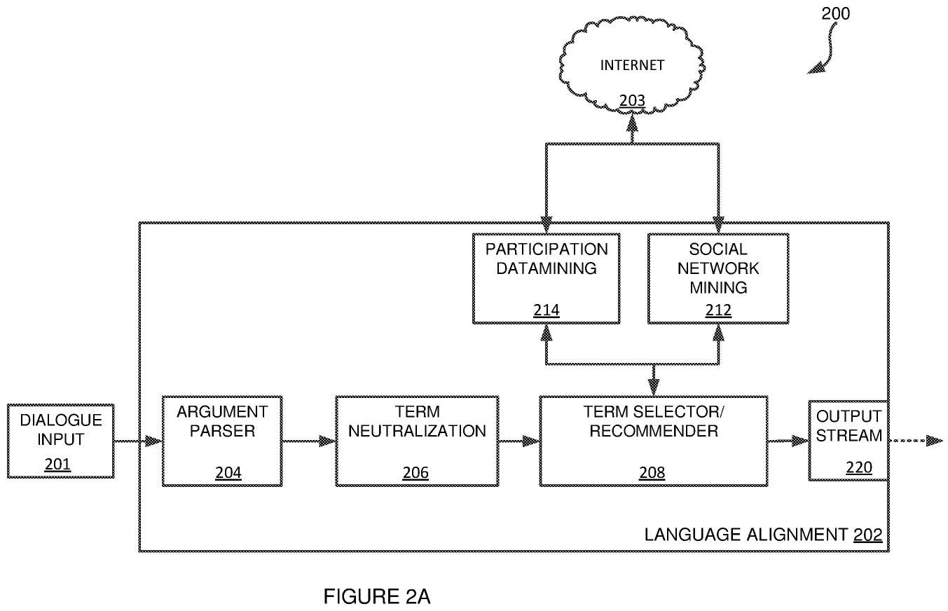

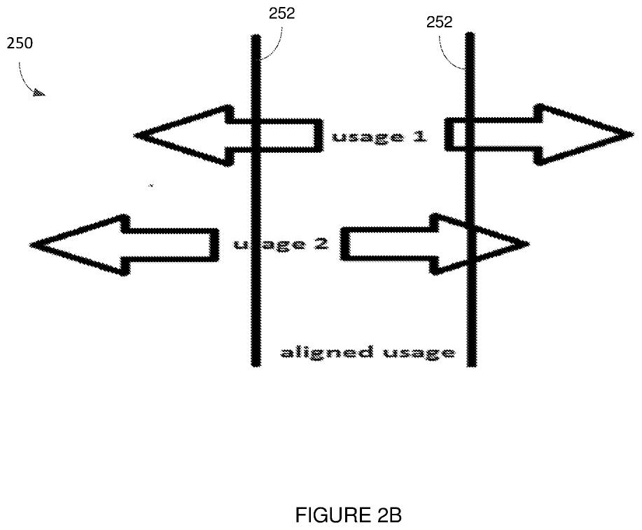

FIG. 2A is a block diagram of a vocabulary alignment system 200 for providing alignment of terms and phrases in a dialogue. A language alignment system 202 receives dialogue input 201. Dialogue input 201 can be streaming (e.g., live) data, batch or bulk uploads, or various other formats including natural language dialogue. Language alignment system 202 also maintains a connection with the Internet 203 in order to provide supplement data for internal processes. In some examples, language alignment 202 may connected to a local network, a virtual network, a remote repository, a data store, or other content sources directly instead of the Internet 203.

An argument parser 204 identifies misaligned terms in dialogue input 201. Argument parser 204 may identify alignment (or, conversely, misalignment) based on term definitions, context of use, arguments or prepositions in which the terms are found, etc. Argument parser 204 further determines argument context and the like which may be provided to downstream processes (e.g., term selector/recommender 208 discussed below).

The identified misaligned terms may also include additional context elements (e.g., the misaligned terms may be emotionally charged or the like) which may be at odds with how respective users are making use of the terms in the received dialogue input 201. A term neutralization 206 may then convert the terms into a neutral form using, for example, a neutral language tree or the like.

Neutralized versions of the identified misaligned terms may then be provided to a term selector/recommender process 208. Term selector/recommender process 208 identifies alternative terminology and/or explanation of the detected misaligned vocabulary usage. Here, term selector/recommender 208 interfaces with a participation datamining process 214 and a social network mining process 212, which both interface with various websites, databases, social networks, and the like on the Internet 203.

Participation datamining 214 may review user participation histories in order to provide additional information in recommending an aligned vocabulary based on, for example, both users in a dialogue (e.g., computers 102A-B). For example, term selector/recommender 208 may consider how each user has historically used the misaligned terms as well as other related terms. Further, term selector/recommender 208 may consider how each user has reacted to related terms (e.g., potential alternative terms) in the past based on, for example, concessions, etc.

Social network mining process 212 may review social networks for respective users in order to provider further additional information in recommending an aligned vocabulary. For example, social network mining process 212 may identify friendly associations and/or political persuasions, etc. for use in determining how a user may react to or interpret particular terms or phrases.

Term selector/recommender 208 provides aligned terms and phrases to output stream 220. In some examples, output stream 220 may provide a readout of term alignment issues to a user through, for example, a computer 102A-B and the like. In some examples, output stream 220 may feed into downstream processes or other integrations for continued treatment and/or processing of aligned terms.

FIG. 2B is an example visualization 250 of a vocabulary alignment. In some examples, visualization 250 can be produced downstream from language alignment system 202.

Visualization 250 depicts a dialogue for which delimiters have been applied to indicate relative vocabulary alignment. For example, where vocabulary usage drifts outside of delimiting range bounds 252, an alert may be provided to a user. Here, usage 1 falls within an alignment range (e.g., bounded by delimiting bounds 252). However, where usage 2 exceeds range bounds 525, an associated user or users can be alerted and/or prompted to modify word choice or manner of use. In some cases, delimiting bounds 252 may be relatively far apart to account for words with broad gradients of meaning (e.g., “good”, “cool”, “bad”, “evil”, etc.) and in other cases delimiting bounds 252 may be relatively compressed where words have exceptionally constrained gradients of meaning such as in the case of highly technical terms and/or terms used in a technical discussion and the like.

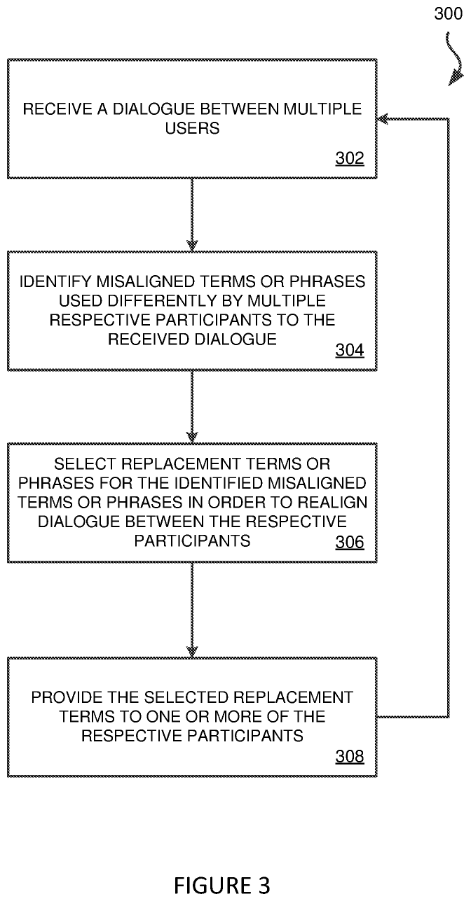

FIG. 3 is a dialogue alignment method 300 for providing aligned terminology to participants to a dialogue. Dialogue alignment method 300 can be performed by system 200. In some examples, dialogue alignment method 300 can be performed on a single computing device, or as a service or collection of services (e.g., micro-services, etc.) hosted by a remote device (e.g., as a server or provided as a web application and the like).

Dialogue is received for processing (302). The dialogue may be between two or more users. In some examples, input such as natural language and the like produced by a single user may be provided and consistency of usage of terms and the like can be checked for by method 300.

Misaligned terms or phrases within the received dialogue are identified (operation 304). Generally, misaligned terms or phrases will be similar or shared terms used by multiple participants to the dialogue which nevertheless are used to mean differing things. In some cases, misaligned terms may be contrary to each other, while in some other cases misaligned terms may simply cause dialogue participants to “talk past each other” and the like.

Replacement terms or phrases are selected which realign dialogue between participants (operation 306). As a result, participants can engage in dialogue with each other without fear of misunderstanding, or being misunderstood by, each other. The selected replacement terms are then provided to the respective participants (operation 308). In some examples, method 300 may provide a continuous/streaming alignment and so operation 302 will immediately proceed again following operation 308.

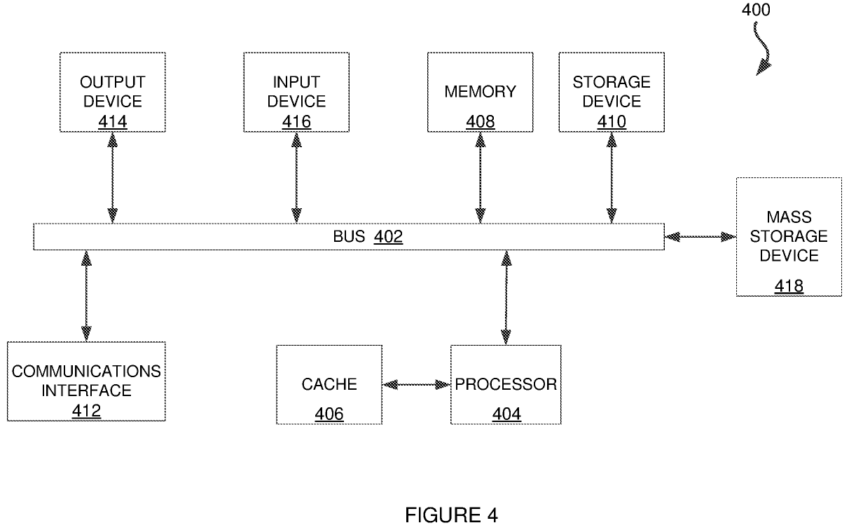

FIG. 4 is an example computing system 400 that may implement various systems and methods discussed herein. The computer system 400 includes one or more computing components in communication via a bus 402. In one implementation, the computing system 400 includes one or more processors 404. The processor 404 can include one or more internal levels of cache 406 and a bus controller or bus interface unit to direct interaction with the bus 402. The processor 404 may specifically implement the various methods discussed herein. Main memory 408 may include one or more memory cards and a control circuit (not depicted), or other forms of removable memory, and may store various software applications including computer executable instructions, that when run on the processor 404, implement the methods and systems set out herein. Other forms of memory, such as a storage device 410 and a mass storage device 418, may also be included and accessible, by the processor (or processors) 404 via the bus 402. The storage device 410 and mass storage device 418 can each contain any or all of the methods and systems discussed herein.

The computer system 400 can further include a communications interface 412 by way of which the computer system 400 can connect to networks and receive data useful in executing the methods and system set out herein as well as transmitting information to other devices. The computer system 400 can also include an input device 416 by which information is input. Input device 416 can be a scanner, keyboard, and/or other input devices as will be apparent to a person of ordinary skill in the art. An output device 414 can be a monitor, speaker, and/or other output devices as will be apparent to a person of ordinary skill in the art.

The system set forth in FIG. 4 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the methods can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a computer-readable storage medium having stored thereon instructions, which may be used to program a computer system (or other electronic devices) to perform a process according to the present disclosure. A computer-readable storage medium includes any mechanism for storing information in a form (e.g., software, processing application) readable by a computer. The computer-readable storage medium may include, but is not limited to, optical storage medium (e.g., CD-ROM), magneto-optical storage medium, read only memory (ROM), random access memory (RAM), erasable programmable memory (e.g., EPROM and EEPROM), flash memory, or other types of medium suitable for storing electronic instructions.

The description above includes example systems, methods, techniques, instruction sequences, and/or computer program products that embody techniques of the present disclosure. However, it is understood that the described disclosure may be practiced without these specific details.

While the present disclosure has been described with references to various implementations, it will be understood that these implementations are illustrative and that the scope of the disclosure is not limited to them. Many variations, modifications, additions, and improvements are possible. More generally, implementations in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for aligning misaligned vocabulary, the method comprising:
receiving a dialogue between two or more participants;
identifying misaligned vocabulary within the received dialogue, the misaligned vocabulary comprising terms or phrases which are used to mean different things by respective participants of the dialogue;
selecting replacement terms or phrases, the replacement terms of phrases corresponding to the identified misaligned vocabulary and providing an alignment of the dialogue; and
providing the selected replacement terms or phrases to one or more of the participants to the dialogue.
